(19) United States
(12) Patent Application Publication
(10) Pub. No.: US 2017/0255758 A1
(43) Pub. Date: Sep. 7, 2017

(54) Pharmaceutical Monitoring and Dose Optimization System

(71) Applicant: Frank Michael Washko, Brush Prairie, WA (US)

(72) Inventor: Frank Michael Washko, Brush Prairie, WA (US)

(21) Appl. No.: 15/062,213

(22) Filed: Mar. 7, 2016

(51) Int. Cl. G06F 19/00

(52) U.S. Cl. CPC G06F 19/3456; G06F 19/3418

(57) ABSTRACT

Disclosed is a device that may monitor the patient's reaction to a particular drug dose, then adjust that dosage for the patient may address some of these concerns. By incorporating this system into a portable electronic device, the system could perform the task of monitoring a patient's outcomes and tailoring the drug dose to the patient by monitoring and adjusting the drug dose between appointments with a doctor. Such a system may be incorporated into a smartphone or tablet, and may interact with an application on the doctor's side so that the doctor may also monitor changes that the application recommends.

### BACKGROUND AND SUMMARY

The present invention relates generally to smart pharmacological systems, and more particularly, to a smart device that monitors a patient's physiological response to drugs, and tailors future drug doses based on the response.

The goal of pharmaceuticals is to obtain a positive patient outcome with the minimum adverse side effects. The optimum dose amount or frequency may be difficult to determine without some degree of monitoring or experimentation. This degree of patient monitoring may be difficult, cost prohibitive, or impractical—particularly in case of outpatient care, where the patient continuously takes a drug for a chronic illness without being monitored in a hospital. In some cases, a patent may be prescribed a drug, then not seen by the doctor again for 6 months, with no monitoring of the drug's effects between appointments. Prescribing a “standard” dose may result in overprescription for a particular patient. The result may be unnecessary adverse side effects or increased drugs costs.

Having a device within the patient's control that may monitor the patient's reaction to a particular drug dose, then adjust that dosage for the patient may address some of these concerns. By incorporating this system into a portable electronic device, the system could perform the task of monitoring a patient's outcomes and tailoring the drug dose to the patient by monitoring and adjusting the drug dose between appointments with a doctor. Such a system may be incorporated into a smartphone or tablet, and may interact with an application on the doctor's side so that the doctor may also monitor changes that the application recommends.

### BRIEF DESCRIPTION OF THE DRAWINGS

FIG. 1 is a system block diagram of one embodiment of the present invention.

FIG. 2 is a flowchart of the operation of one embodiment of the present invention.

FIG. 3 shows two user interface screens of one embodiment of the present invention.

FIG. 4 is a flowchart of the operation of another embodiment of the present invention.

### DETAILED DESCRIPTION

While the exemplary embodiments illustrated herein may show various features, it will be understood that the different features disclosed herein can be combined variously to achieve the objectives of the present invention.

One simple example of the invention is a smartphone or tablet that has a software application installed. That software app may ask a patient taking a daily dose to record their reaction to the drug. If the reaction is positive, the application may instruct the amount of drug taken (dose amount or frequency) by some amount. Then, later, the app will ask the patient for their reaction to the new, reduced, drug dose. Based on the reaction, that dose may be further reduced, or increased back to the original amount.

In pharmacology, the dose is the amount of a drug taken at any one time. It can be expressed as the weight of a drug (e.g. 250 mg), volume of a drug solution (e.g. 10 mL, 2 drops), the number of a dosage form (e.g. 1 capsule) or some other quantity (e.g. 2 puffs). Dosage regimen is the frequency at which the drug doses are given. Examples include 2.5 mL twice a day, one tablet three times a day, or one injection ever four weeks. For the purposes of this disclosure, the term “dose” means either dose amount or dose frequency. Therefore, when the app modifies the dose, it may modify the dose amount, the dose regimen, or both. Or, the app may modify any other dose parameter known in the art or arising in the technology.

Accordingly, one objective of the present invention is to have all necessary monitoring and dose adjustment capabilities within a single electronic device. In one embodiment, the device may include: a processor, memory, a display screen, a keyboard, network communications hardware, and software for interacting with the patient to determine outcomes and provide dose modifications.

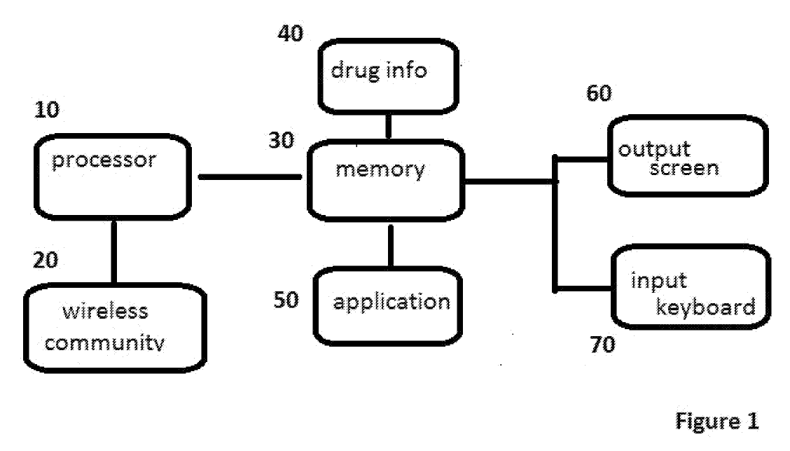

Turning to FIG. 1, this figure shows a block diagram of the system. The system consists of an electronic device, such as a computer, smartphone, tablet, smartwatch, or other similar device, with a memory 30. The software application may be downloaded into the memory 30, which interacts with a processor 10, and in communication with a wireless communication circuit 20. Resident in the memory is the pharmaceutical application 50 and information about the drug the patient is taking 40. The memory 30 then interacts with the patient by outputting information 60 to the user, such as a time to take his or her drug, and a query asking for data to be input by the user. Then the memory takes in data input 70 from the user, such as physiological data, questionnaire information, or any other data relevant to drug dosing. The memory 30 then uses logical in the processor 10, data about the drug 40, and the data input 70 from the user to calculate a new dosage amount to output to the user at 60. The network interface 20 can provide a plurality of additional features for the app, including: downloading drug profiles, downloading drug interaction effects for multiple drugs, downloading drug side effects, downloading patient data to query, downloading patient questionnaires, sending data to the patient's doctor (or lab, or other data analysis station), sending alerts to the doctor, sending emergency alerts, receiving messages from the doctor, receiving dose changes from the doctor, sending prescriptions to a pharmacy (or doctor), or other similar function to send information about the drug usage, patient, or results data. For the purposes of this application reporting information to a patient's “doctor” may also mean reporting the information to a pharmacist, lab technician, or other person who analyzes the patient's data and drug usage.

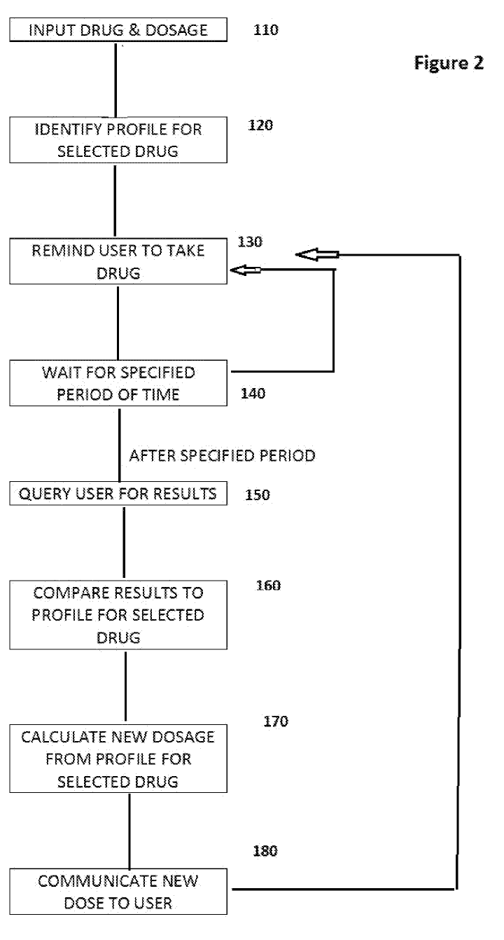

Turning to FIG. 2, this figure shows a flowchart of the operation of one embodiment of the present invention. In this embodiment, the patient may first input the drug 110 he or she is using into the app, as well as the dose that has been prescribed. Alternatively, it may be selected from a list or input by the patient's doctor. Next, the app identifies the profile for the drug 120, which may be resident in the memory 30, downloaded from a remote server over the wireless connection 20, or input by the doctor. Next, the app enters a loop. If the patient is required to take one dose amount once a day, the app may remind the patient to do so 130 for a specified period (once a day) 140, along with a reminder to input the data results that are being monitored 150. Then, the app may be instructed to repeat this cycle for a period of time, such as a month. Then, at the end of a month, the app may compared the data input over the month and compare that to a profile for the drug 160. Then, the app may calculate a new dose 170 for the patient to change to. Next, the app may communicate that new dose to the patient 180. Finally, the app reverts back to the cycle at 130, of altering the user to take the new dose 130, waiting for a day 140, and collecting the data input by the patient 150. Then, at the end of the next month (or any other specified time period), the app performs 160, 170, and 180, again adjusting the dose instructed for the patient to take. The app may be then repeat this cycle, adjust the drug amount for as long as the patient takes the drug. Obviously, these steps are representative of one embodiment of the operation of the system, and any other method or logic that could accomplish the same results are within the spirit of this invention. The time periods may be adjusted, the app may interact with doctor approval or input at any time, or the user may input data at various times. Also, there are a variety of ways that the dose could be adjusted, or that drug data may be integrated into the application. FIG. 2 represents a basic system, but there are numerous opportunities for interaction with other sources over a network. The reminder aspect of the system is optional.

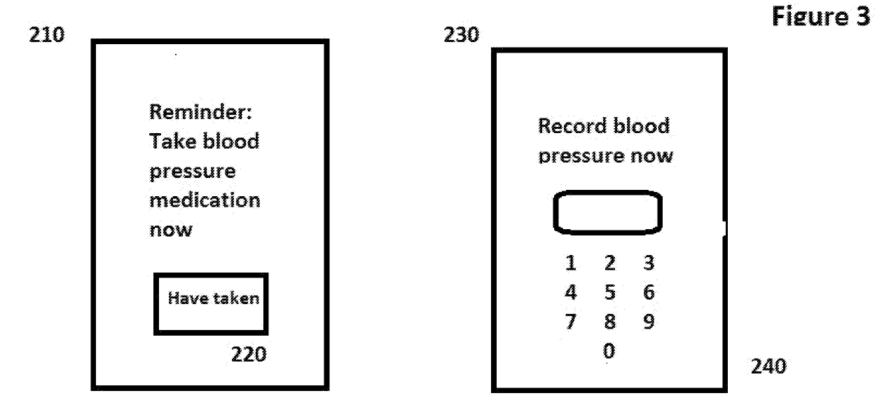

Turning to FIG. 3, this figure shows a user interface for the pharmaceutical app. The app may have one screen that gives the patient a reminder 210 to take his or her drug dose. Then, the app may ask for input 220 whether the dose was taken. With this optional feature, the app can record not only the physiological data input by the user, as well as times that he dose was missed over the monitoring period. Then, the app may use that information when it is calculating the new dose. Next, the app may provide a screen to ask for physiological results from the user 230. The patient may then put in the requested data with a keypad, touch screen, voice input, or any other input method known in or arising in the art. For example, the app may request blood pressure data daily (or weekly), or blood test results, or whether the patient is free from pain, or a pain scale from 1 to 10, or a questionnaire of adverse side effects, or any other physiological data useful to the application or the patient's doctor. In addition, the “input” may also be automatic, without the patient's effort, for example, by taking measurements of heart rate from the user's smart watch.

In the example of one embodiment, a patient may be prescribed medication designed to lower blood pressure from 130 to 120. A patient may take the drug once a day, and the app may request the patient to record their blood pressure each day. After averaging some period of data, the app may determine that the average blood pressure is now 110. Then, the app may suggest to the patient to reduce the amount of the drug that they take by 5%, or alternatively, may instruct the patient to take the same dose once every two days. The app may then continue to monitor the patient's blood pressure over time. Then, at some time period, it may again suggest that the patient either reduce or increase his or her dose. In another embodiment, the system may also communicate wirelessly with a patient's blood pressure monitor to automatically collect the data from the patient without querying them. This could be done with the Bluetooth protocol, or similar wireless system.

In another embodiment, a patient may be prescribed medication to reduce their arthritis pain symptoms. Here, the patient may take a standard dose for some period of time, and the system may ask the patient whether they are feeling any pain. If the patient answers that they are not, the app may suggest a reduction in the amount of drug taken. If, in the next time period, the patient records that they have felt no pain with the reduced dose, the app may again prescribe a further reduction in drug dose. If, at some period, the patient records some pain, the app may instruct the patient to increase his or her dose. Alternatively, if the patient continues to record no pain, the app may then begin to perform a design of experiments (DoE), adjusting both dose amount and dose frequency, to essentially find an optimum dose of a drug for a patient.

In additional embodiments of this system, the app may use the wireless capabilities of the smartphone or tablet to report the patient results, and the suggested dose changes, to the patient's doctor remotely. This may be done as single alerts, or as a series of data recorded for the patient, or other method for the doctor to visualize and understand patient outcomes. In this embodiment, the doctor may also have the ability to remotely adjust the dose, or override the suggested dose from the app, and have the app communicate that to the patient. The doctor's app may also have the ability to let the doctor send messages, alerts, or data collection question to the patient. In yet another embodiment, the doctor-side app may be a corresponding version of the same app on the patient's smartphone, such that the two corresponding apps are interoperable and interact with each other.

In yet another embodiment, a patient may be taking a drug that is intended to have psychological result. For example, a patient may be prescribed an antidepressant. In this case, the app may collect data that is not numeric, but is qualitative. For example, the app may ask the mood of the patient, if they are feeling suicidal, or if they have laughed during the day. Then, the app may adjust the drug dose based on those responses. The app may also ask questions related to side effects. For example, the app may ask the patient if they have had dizziness. If the patient reports that he or she is happy, but has had dizzy spells, the app may reduce the dose of the drug, and further, report the dizziness to the doctor's app.

Thus, in various embodiments of the present invention, the app may monitor various types of patient reactions and responses whether they are quantitative or qualitative. In addition, the app may monitor any type of chemical or biological response arising in the art, include methods to monitor bodily fluids or blood chemistry. In yet another embodiment, the patient app may receive data directly from a third party wirelessly. For example, the patient may visit a lab for a blood test. Then, the results of the blood test may be sent to the patient's app, and the app may adjust the patient's dose based on those results. Further, the app may interface directly with a biological monitoring device that the user wears, for example, a smartwatch that monitors heart rate.

In terms of system algorithms, the application may adjust the user's dose in any number of ways known in the art, or arising. As one example, the app may download an adjustment from a source, such as the drug manufacturer. A drug profile may be how a dosage should change with time, or how it should change with the physiological response data of the user, or any other drug dosage profile known in the art for determining how a dose should be changed for a patient. Or, the app may be preprogrammed with an adjustment profile, and hold the adjustment profile resident in memory. Such a profile could be a set amount of adjustment, such as adjusting the dosage down 5% at each interval when a patient's dose is working well. Or, it could be a set amount of milligrams adjustment, or a set interval of time, such as adding a day between doses. In another embodiment, a drug profile may be non-linear, such that the change in dose changes over the amount of time a patient has been using the drug. In yet another embodiment, a drug dose profile provided by the drug manufacturer, or a doctor, may be a non-linear curve of drug amount, versus efficacy. For example, large adjustments in dose may be necessary initially, but may reach a threshold value, below which the drug may no longer be effective. As an alternative, the adjustment profile may be input directly by the doctor, or the doctor could override the standard profile for a drug. A drug profile, may also be a curve relating the expected pharmacological response of a drug compared to the dose over time, or may be one or more equations that relate a pharmacological response to the dose administered. For the purpose of this disclosure, a drug profile may be any relationship known in the art that relates a drug dose to its response, or a pharmacological response to a change in dosage amount.

These drug algorithms may be present in the drug information 40, calculated by the logic in the processor 10, provided directly by input from the doctor (or his corresponding app), some combination of the above, or by any other method known in the art for calculating or adjusting pharmacological doses.

In yet another embodiment, the application may be a learning algorithm. For example, the app may calculate patient data over time and perform a sensitivity analysis of the patient's reaction to changes in the drug. For example, the app may suggest a 5% reduction in drug dose of a blood pressure medication, and expect a reduction of 2 millimeter of mercury of pressure. Then, if the user reports a 5 millimeter of mercury reduction at the next reporting period, the app may limit further reductions in drug dose to 3%. In yet another embodiment, the app may perform a design of experiments (DoE) with the patient's data. For example, the drugs may first suggest a reduction in milligrams of drug dose, the record the effects of the new dose on the patient. In the next adjustment period, the app may suggest the original dose, but with an extra day between doses. Then, the app may record the effect of the decreased frequency. At the next reporting period, the app may suggest a combination of the two, thus optimizing the results of a multivariate problem.

In another embodiment, the app may determine a new recommended dosage from a lookup table for the particular drug. The lookup table may be simple and based on a patient's reaction to a specific drug. However, it may also take into consideration other factors about the patient. For example, the app may ask the user not only the drug that he or she is now taking, but also factors such as: age, weight, sex, ethnicity, whether they smoke, whether they drink, information about liver or kidney function, or any other information that may be useful in determining dosages.

In yet another variation, the app may be cognizant of several drugs that the patient is taking, and their interactions. If the app is aware that a patient is taking one drug for blood pressure, but also taking another drug that may have a tangential effect on blood pressure, it may use the knowledge of these multiple drugs and change its adjustment suggestions accordingly. In a more complex version of the system, the app may perform an even more complicated multivariate design of experiments to adjust multiple drugs simultaneously and record the results to find the optimum doses of multiple drugs.

In another variation of the cases where a patient is taking multiple drugs that are tracked by the app, the app may perform a check to see if there is a harmful interaction between the drugs the patient is taking, and may send an alert or instruct the patient to suspend usage of the drug. This may be particularly helpful where a patient receives prescriptions from multiple doctors.

In yet another embodiment, the app may include an additional module to re-check the dose recommended to a user to determine if the dose recommendation is above, or below, a threshold safe level. Thus, the app may override a calculated dose based on presets for the drug. Or, the app may alert the patient to report to a hospital immediately based on a calculated dose, or based on data input from the user. As a further feature, the app may send an alert directly to a doctor of data received from a patient indicates a dangerous condition.

In another embodiment of the system, the app may serve as a conduit to communicate information to the patient's doctor without having to report to the doctor for a full appointment. An optional part of this embodiment is a doctor-side app corresponding to the patient's app. In this system, the data recorded by the app may be sent to the doctor's app, where it can be visualized over time. Also, the app may send alerts to the doctor's app to know that a dose is being changed. On the doctor's app, the dose change could be reviewed, or approved, or overridden. In addition, the doctor may have the capability to change a dose amount at any time, when reviewing the patient's data. In another design, the patient may record information, such as side effects, without being asked, and send that information to the doctor. Then, the doctor could review the alert, and note the effect, change the dose, respond with a message to the patient, tell the patient to come in for an appointment, or so on. Therefore, a doctor can be made aware of the effects of a drug on a patient in real time, between regular appointments.

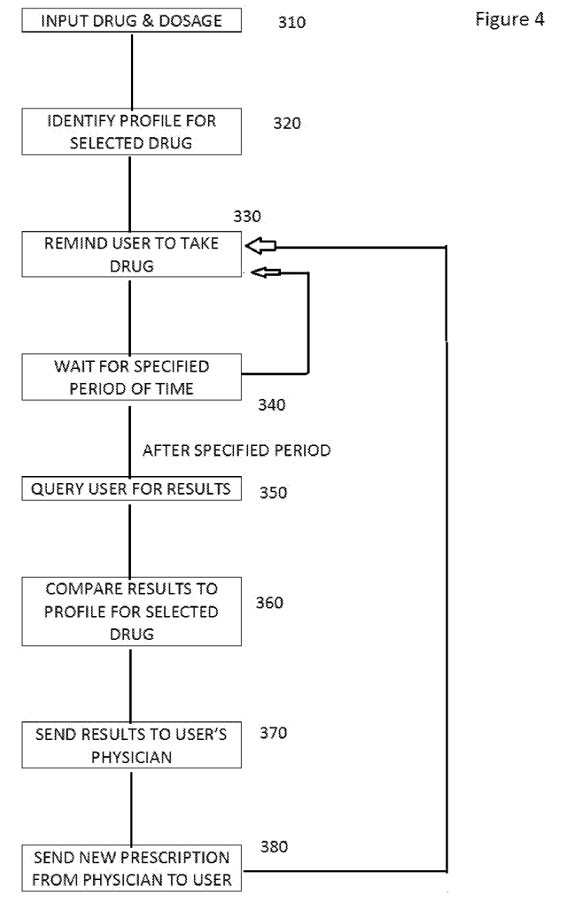

Turning to FIG. 4, this figure shows another embodiment of the present invention. In this embodiment, the system may not suggest new doses. But, it may perform the function of checking harmful drug interactions and alerting the patient or doctor. This may be particularly helpful if a patient has a prescription from one doctor, but then gets a new prescription from another doctor; the app can keep track of both. And, the app may also offer the possibility of the doctor reviewing the patient's reaction data recorded by the app remotely. And, the doctor may send a new prescription from his corresponding app. This may be in the form of an electronic prescription that the patient could take into a pharmacy, with a visual image of the prescription or a bar code. Or, it could be an electronic prescription sent directly to the pharmacy over a network connection. And, any of these features could be combined into different system configurations—with or without the automatic dose changes feature built into the app. In yet another embodiment of the concept, the doctor-side application may have provisions for the doctor to bill for his review of patient data, or bill for messages sent, automatically by the app recording the doctor's interaction with the app.

In this embodiment, the patient may first input the drug 310 he or she is using into the app, as well as the dose that has been prescribed. Alternatively, it may be selected from a list or input by the patient's doctor. Next, the app identifies the profile for the drug 320, which may be resident in the memory 30, downloaded from a remote server over the wireless connection 20, or input by the doctor. Next, the app enters a loop. If the patient is required to take one dose amount once a day, the app may remind the patient to do so 330 for a specified period (once a day) 340, along with a reminder to input the data results that are being monitored 350. Then, the app may be instructed to repeat this cycle for a period of time, such as a month. Then, at the end of a month, the app may compared the data input over the month and compare that to a profile for the drug 360. Or, 360 may be skipped, and the app move directly to 370 where the results (or the comparison) is sent to the patient's doctor. Next, the doctor may issue a new prescription to the patient 380 after review of the results. This prescription may be communicated in a number of different ways, including a graphical representation of a prescription, an electronically-signed prescription, a coded (bar code or other type of encoding) prescription that can be scanned or transferred wirelessly to a pharmacy, or sent electronically from the physician to the user's pharmacy, where the user can go to get the new prescription. Or, if the prescription is able to be modified by the user directly, then the prescription may be implemented just by the user after receiving it. Finally, the app reverts back to the cycle at 330, of altering the user to take the new dose 330, waiting for a day (or other time period) 340, and collecting the data input by the patient 350. Then, at the end of the next month (or any other specified time period), the app performs 360, 370, and 380, again adjusting the dose and issuing a new prescription to the patient. The app may be then repeat this cycle, adjust the drug amount for as long as the patient takes the drug. Obviously, these steps are representative of one embodiment of the operation of the system, and any other method or logic that could accomplish the same results are within the spirit of this invention. The time periods may be adjusted, the app may interact with doctor approval or input at any time, or the user may input data at various times. Also, there are a variety of ways that the dose could be adjusted, or that drug data may be integrated into the application.

In another embodiment of the system, the app (or system of two apps) may have a wireless connection to a pharmacy system. The pharmacy system could include an app corresponding to the patient's app, or a system in a different format. Interacting with the pharmacy, the app could send changes to the prescription directly to the pharmacy for the patient to pick up. This is in alternative to a drug that a patient can change the dose of himself, by changing an injection amount, for example. For example, if the app suggests a 5% reduction in dose amount, the app could report directly to the patient's pharmacy to prepare a prescription with a 5% reduction in dose for the patient to pick up at his next visit. Alternatively, the app could report the suggested reduction to the doctor, who may then approve the dose change and send that change directly to the pharmacy from the doctor-side application. In this embodiment, the corresponding pharmacy app may have the same capabilities of the doctor-side app described above—to receive alerts and review patient data over time. Thus the system could be a two-way system between the patient and pharmacy, or a three-way app between the patient, pharmacy, and doctor. This embodiment may make it easier to modify a patient's dose without the time and cost of reporting to the doctor to pick up a new prescription.

Any combination of the above features and options could be combined into a wide variety of embodiments. It is, therefore, apparent that there is provided in accordance with the present disclosure, systems and methods for monitoring pharmacological usage and prescriptions. While this invention has been described in conjunction with a number of embodiments, it is evident that many alternatives, modifications, and variations would be, or are apparent to, those of ordinary skill in the applicable arts. Accordingly, applicants intend to embrace all such alternatives, equivalents, and variations that are within the spirit and scope of this invention.

What is claimed is:

1. A drug usage monitoring and adjustment system comprising:
a processor,
memory in communication with said processor,
a network interface in communication with said processor,
a visual output system,
an input system,
a module for providing an output on the visual output system, for requesting drug results data from a user regarding the results of using said drug,
a module for accepting said drug results data from said user using said input system, and storing said drug results data in said memory, and
a module for outputting a revised drug dose to said user using said visual output system.

2. The drug monitoring and adjustment system of claim 1, further comprising:
a module for sending said drug results data to a remote source using said network interface, and
a module for receiving said revised drug dose from said remote source using said network.

3. The drug monitoring and adjustment system of claim 2, wherein said remote source is the user's doctor.

4. The drug monitoring and adjustment system of claim 2, wherein said remote source is a network resource, wherein said remote source comprises a module for storing dose information about a drug in said memory, and a module for analyzing said drug results data from said user with said dose information about the drug to determine a revised drug dose for said user.

5. The drug monitoring and adjustment system of claim 1, further comprising:
a module for storing dose information about a drug in said memory, and
a module for analyzing said drug results data from said user with said dose information about the drug using said processor, to determine a revised drug dose for said user.

6. The drug monitoring and adjustment system of claim 5, wherein said dose information about a drug is a fixed dose modification amount based on said drug results data.

7. The drug monitoring and adjustment system of claim 5, wherein said dose information about a drug is a lookup table.

8. The drug monitoring and adjustment system of claim 5, wherein said dose information about a drug is a dosage profile for the drug.

9. The drug monitoring and adjustment system of claim 5, wherein said dose information about a drug is received from a remote source over said network interface.

10. The drug monitoring and adjustment system of claim 5, wherein said dose information about a drug is input by the prescribing doctor of the drug.

11. The drug monitoring and adjustment system of claim 5, further comprising a module for accepting physiological data from said user using said input system, and wherein said module for analyzing also uses said physiological data to determine said revised drug dose.

12. The drug monitoring and adjustment system of claim 5, wherein said module for analyzing stores several time periods of drug results data input by said user to analyze how the user has reacted to past drug dose revisions to determine the revised drug dose for the latest time period.

13. The drug monitoring and adjustment system of claim 1, further comprising:
a module for storing dose information about multiple drugs in said memory, and
a module for analyzing said drug results data from said user with said dose information about the multiple drugs using said processor, to determine multiple revised drug doses for said user that considers the interactions of the multiple drug dose revisions on said drug results data.

14. The drug monitoring and adjustment system of claim 13, wherein said module for storing dose information further stores harmful interactions between drugs.

15. The drug monitoring and adjustment system of claim 14, wherein said module for storing dose information alerts said user of a harmful interaction may result from a new drug prescribed to said user with a drug the user has previously been monitoring.

16. The drug monitoring and adjustment system of claim 1, further comprising:
a module for sending said drug results data to the user's doctor using said network interface,
a module for receiving said revised drug dose from the user's doctor using said network, and
a module for receiving a revised prescription for said revised drug dose using said network.

17. The drug monitoring and adjustment system of claim 16, wherein said revised prescription is an electronic graphical representation of a prescription displayed on said visual output system.

18. The drug monitoring and adjustment system of claim 1, further comprising a drug monitoring and adjustment system remote from said user and used by said doctor, comprising:
a processor,
memory in communication with said processor,
a network interface in communication with said processor,
a visual output system,
an input system,
a module for receiving said drug results data from said user using said network interface,
a module for sending said revised drug dose from said doctor using said network, and,
a module for sending a revised prescription for said revised drug dose using said network interface.

19. The drug monitoring and adjustment system of claim 18, wherein said revised prescription for said revised drug dose is sent directly to a pharmacy using said network interface.

20. The drug monitoring and adjustment system of claim 1, wherein said drug monitoring and adjustment system is one of: a smartphone, a tablet, or a watch.
